(19) United States
(12) Patent Application Publication
(10) Pub. No.: US 2022/0412143 A1
(43) Pub. Date: Dec. 29, 2022

(54) FLEXIBLE COUPLING AND ACTUATOR

(71) Applicant: Magna Automotive Parts (Suzhou) Co., Ltd., Suzhou (CN)

(72) Inventors: Bo TANG, Suzhou (CN); Guang Chun LI, Suzhou (CN); Ying ZHU, Suzhou (CN)

(21) Appl. No.: 17/852,793

(22) Filed: Jun. 29, 2022

(30) Foreign Application Priority Data
Jun. 29, 2021 (CN) 202110726918.4

(51) Int. Cl. E05F 15/622

(52) U.S. Cl. CPC E05F 15/622; E05Y 2201/224; E05Y 2201/702; E05Y 2600/60; E05Y 2900/546

(57) ABSTRACT

A flexible coupling and an actuator for shaft-driven structures are provided. The flexible coupling includes a first half coupling, a second half coupling and a flexible member connected between the first half coupling and the second half coupling. One end face of the flexible member is provided with at least two connection portions extending along the axial direction. The first half coupling includes a support portion configured to support the radially inner surface of each connection portion and first transmission portions configured to fill circumferential gaps between the connection portions. The second half coupling includes second transmission portions equal in number to the connection portions. The second transmission portions cover radially outer side surfaces of the connection portions in a one-to-one manner. The flexible coupling can prevent the flexible member from being disengaged from between the two half couplings during operation. The actuator includes the preceding flexible coupling.

### CROSS-REFERENCE TO RELATED APPLICATION

This application claims the benefit of China Application Serial No. 202110726918.4, filed Jun. 29, 2021, which is incorporated herein by reference in its entirety.

### TECHNICAL FIELD

The present invention relates to the technical field of shaft-driven structures and, in particular, to a flexible coupling and an actuator.

### BACKGROUND

The auto door opening and closing actuator (hereinafter referred to as the actuator) of a motor vehicle is an important part of the door switch. With the development of technical conditions, more and more medium- and high-end vehicles are equipped with actuators.

Usually, to protect the normal operation of the drive mechanism (for example, motor or gearbox) in the actuator, large impact load or torsional vibration needs to be separated from the drive mechanism. In addition, to compensate and absorb the angular misalignment and axial misalignment which occur during the assembly process of the actuator, the actuator needs to be equipped with a flexible coupling.

As shown in FIG. 1 and FIG. 2, a flexible coupling commonly used in the preceding actuator is composed of two half couplings 1′ made of metal and one flexible member 2′ made of rubber. Since the half couplings 1′ limit the position of the flexible member 2′ in a restricted manner in the axial and radial directions, the flexible member 2′ has a certain chance of being disengaged from between the two half couplings 1′ when there is angular misalignment or an axial gap between the two half couplings 1′, resulting in a transmission failure.

In view of the above, there is a technical solution in which a sleeve structure is added to the two half couplings 1′ or one of the half couplings 1′. The sleeve can be completely or partially sleeved on the periphery of the flexible member 2′ to prevent the flexible member 2′ from being disengaged from between the two half couplings 1′. However, the structure is complex and inconvenient to assemble. Moreover, the sleeve, the half coupling 1′ and the flexible member 2′ are prone to wear.

Therefore, the preceding problems need to be solved urgently.

### SUMMARY

An object of the present invention is to provide a flexible coupling. The flexible coupling can prevent the flexible member of the flexible coupling from being disengaged from between two half couplings during operation. The flexible coupling has a simple structure and is easy to assemble.

A further object of the present invention is to provide an actuator having a power drive unit coupled to a telescoping unit by a flexible coupling. The flexible coupling can prevent a flexible member of the flexible coupling from being disengaged from between the power unit and the telescoping unit during operation. The flexible coupling has a simple structure and is easy to assemble.

To achieve this object, the present invention adopts the technical solutions below.

The flexible coupling includes a first half coupling, a second half coupling and a flexible member connected between the first half coupling and the second half coupling. One end face of the flexible member is provided with at least two connection portions extending along the axial direction. The first half coupling includes a support portion configured to support a radially inner surface of each connection portion and first transmission portions configured to fill circumferential gaps between the connection portions. The second half coupling includes second transmission portions equal in number to the connection portions. The second transmission portions cover radially outer side surfaces of the connection portions in a one-to-one manner.

Preferably, the flexible coupling further includes a stop portion disposed between the flexible member and the first half coupling or between the flexible member and the second half coupling. The stop portion is configured to limit the movement of the flexible member relative to the first half coupling or the second half coupling.

Preferably, the stop portion includes a first insertion portion disposed on the flexible member and a second insertion portion disposed on the first half coupling or the second half coupling. The first insertion portion is inserted in the second insertion portion along the radial direction when the flexible member is mounted on the first half coupling or the second half coupling.

Preferably, the flexible member further includes first separation portions. The first separation portions are configured to separate the first transmission portions from the second transmission portions.

Preferably, the first half coupling and the second half coupling include a first flange portion and a second flange portion, respectively. The first flange portion and the second flange portion are configured to clamp the flexible member.

Preferably, the flexible member further includes second separation portions. The second separation portions are configured to separate the first transmission portions from the second flange portion.

Preferably, the flexible member further includes third separation portions. The third separation portions are configured to separate the second transmission portions from the first flange portion.

Preferably, the connection portions are uniformly distributed along the circumference of an end face of the flexible member.

Preferably, the support portion and the first transmission portions are integrally formed in the first half coupling. Moreover, the second transmission portions are integrally formed in the second half coupling.

The object of the present invention is to further provide an actuator which can avoid a transmission failure caused by the disengagement of the flexible member of the coupling.

To achieve this object, the present invention adopts technical solutions described below.

An actuator includes the preceding flexible coupling.

The beneficial effects of the present invention are described below.

With regard to the flexible coupling provided by the present invention, in the radial direction, the connection portions of the flexible member are each limited between the support portion of the first half coupling and a second transmission portion of the second half coupling. Moreover, the angle between two adjacent connection portions is set to not greater than 180 degrees. Thus, the flexible member can be prevented from being accidentally disengaged when the first half coupling and the second half coupling have angular misalignment and axial misalignment or when the flexible member is aged and shrinks due to long-term use.

Since the actuator provided by the present invention is equipped with the preceding flexible coupling as the shaft member torque transmission member, the transmission failure caused by the disengagement of the flexible member of the flexible coupling can be avoided so that the operation action can be performed effectively for a long time.

### BRIEF DESCRIPTION OF DRAWINGS

FIG. 1 is a perspective view of a motor vehicle having a closure panel with at least one, and shown as a pair of actuators constructed in accordance with an aspect of the disclosure, with the actuators being configured to move the closure panel between closed and open positions.

FIG. 2 is a cross-sectional view taken generally along the line 2-2 of one of the actuators of FIG. 1.

FIG. 3 is an enlarged view of the encircled area 3 of FIG. 2.

FIG. 4 is a side elevation view of a flexible coupling of the actuator of FIG. 2 according to an embodiment of the present invention.

FIG. 5 is an exploded front perspective view of the flexible coupling of FIG. 4.

FIG. 6 is a partially assembled front perspective view of the flexible coupling of FIG. 4.

FIG. 7 is a partially assembled rear perspective view of the flexible coupling of FIG. 4.

FIG. 8 is a side elevation view of a flexible coupling in accordance with the prior art.

FIG. 9 is an exploded side elevation view of the flexible coupling of FIG. 8.

Reference list

| | |
|---|---|
| 1′ | half coupling |
| 2′ | flexible member |
| 1 | first half coupling |
| 11 | first base |
| 12 | support portion |
| 13 | first transmission portion |
| 14 | first flange portion |
| 2 | second half coupling |
| 21 | second base |
| 22 | second transmission portion |
| 23 | second flange portion |
| 24 | second insertion portion |
| 3 | flexible member |
| 31 | third base |
| 32 | connection portion |
| 33 | first insertion portion |
| 34 | recess |
| 35 | first separation portion |
| 36 | second separation portion |
| 37 | third separation portion |

### DETAILED DESCRIPTION

The present invention is further described hereinafter in detail in conjunction with drawings and embodiments. It is to be understood that the embodiments described herein are intended to explain the present invention and not to limit the present invention. Additionally, it is to be noted that for ease of description, only part, not all, of the structures related to the present invention are illustrated in the drawings.

In the description of the present invention, unless otherwise expressly specified and limited, the term “connected to each other”, “connected”, or “fixed” is to be construed in a broad sense, for example, as permanently connected, detachably connected, or integrated; mechanically connected or electrically connected; directly connected to each other or indirectly connected to each other via an intermediary; or internally connected or interactional between two components. For those of ordinary skill in the art, specific meanings of the preceding terms in the present invention may be understood based on specific situations.

In the present invention, unless otherwise expressly specified and limited, when a first feature is described as “above” or “below” a second feature, the first feature and the second feature may be in direct contact or be in contact via another feature between the two features. Moreover, when the first feature is described as “on”, “above” or “over” the second feature, the first feature is right on, above or over the second feature or the first feature is obliquely on, above or over the second feature, or the first feature is simply at a higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the description of this embodiment, the orientation or position relationships indicated by terms “above”, “below”, “right” and the like are based on the orientation or position relationships shown in the drawings, merely for ease of description and simplifying operation, and these relationships do not indicate or imply that the referred device or element has a specific orientation and is constructed and operated in a specific orientation, and thus they are not to be construed as limiting the present invention. In addition, the terms “first” and “second” are used only to distinguish between descriptions and have no special meaning.

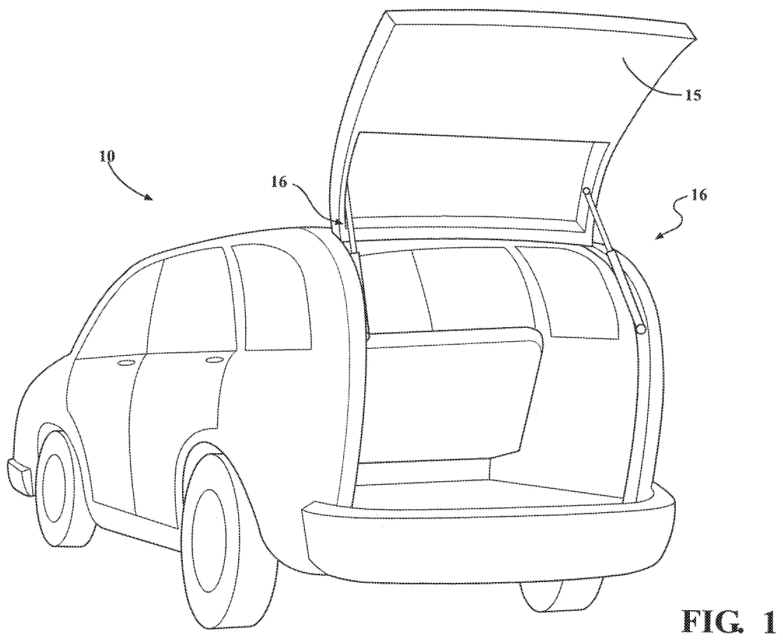

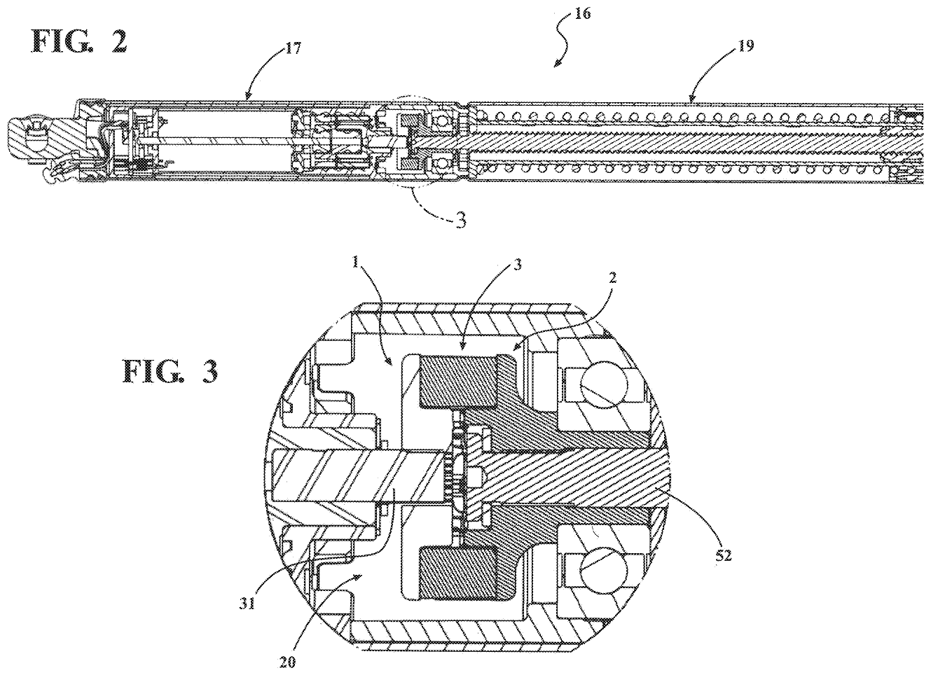

Referring to FIG. 1, a motor vehicle 10 having a closure panel, such as a swing door, and shown as a rear hatch 15, by way of example and without limitation, has at least one electromechanical actuator, also referred to as spindle, and shown as a pair of spindles 16, configured for powered movement of the rear hatch 15 between closed and open positions. The spindle(s) 16 can be provided essentially as disclosed in US Publication No. 2019/0211604A1, filed on Jan. 2, 2019 under U.S. Ser. No. 16/238,128, which is incorporated herein by way of reference in its entirety, though including a flexible coupling 20, as discussed hereafter.

The embodiment disclosed herein includes flexible coupling 20. The flexible coupling 20 can be applied to a shaft-driven mechanism to compensate and absorb the angular misalignment and axial misalignment between a driving shaft 51 of a power drive unit 17 and the driven shaft S2 of a telescoping unit 19 during the assembly process and/or the operation process. Therefore, the flexible coupling 20 can be applied to various types of actuators and working equipment, for example, auto door opening and closing actuators of motor vehicles, such as shown in spindle 16, pumps, fans, and machine tools. These actuators and working equipment are not limited.

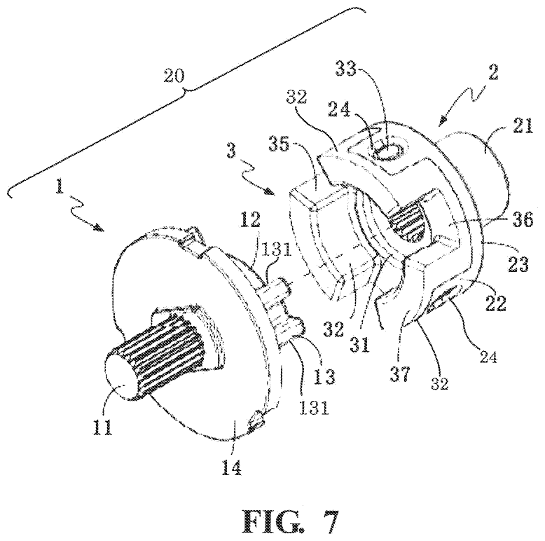

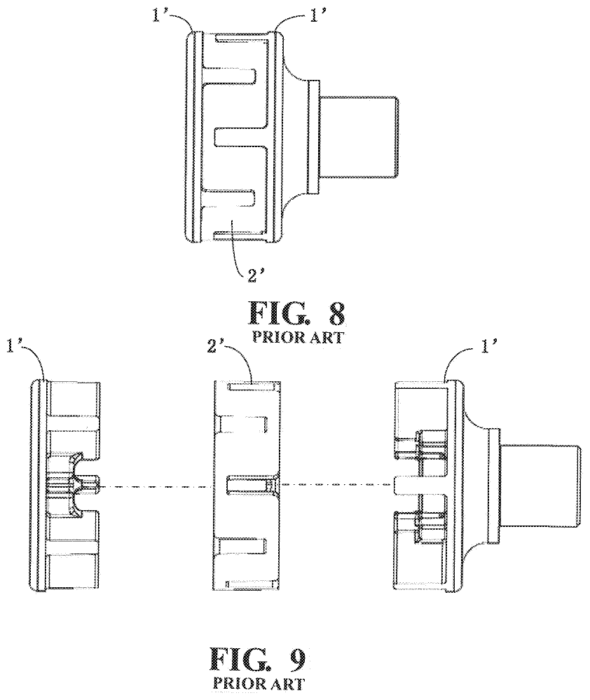

Referring to FIGS. 3-7, the flexible coupling 20 includes a first half coupling 1, a second half coupling 2 and a flexible member 3 connected between the first half coupling 1 and the second half coupling 2. One end face of the flexible member 3 is provided with at least two connection portions 32 extending along the axial direction. The first half coupling 1 includes a support portion 12 configured to support a radially inner side surface A of each connection portion 32 and first transmission portions 13 configured to fill circumferential gaps between the connection portions 32. The second half coupling 2 includes second transmission portions 22 equal in number to the connection portions 32. The second transmission portions 22 cover radially outer side surfaces B of the connection portions 32 in a one-to-one manner.

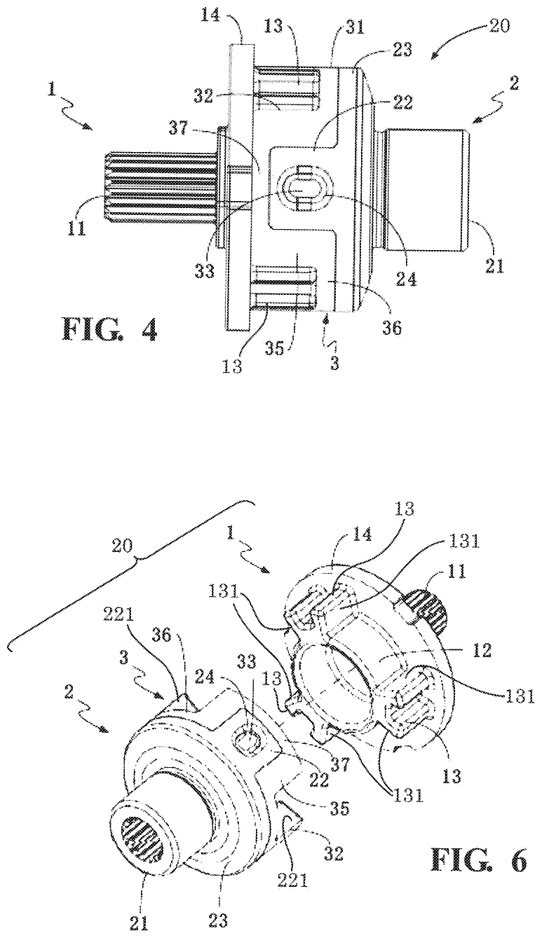

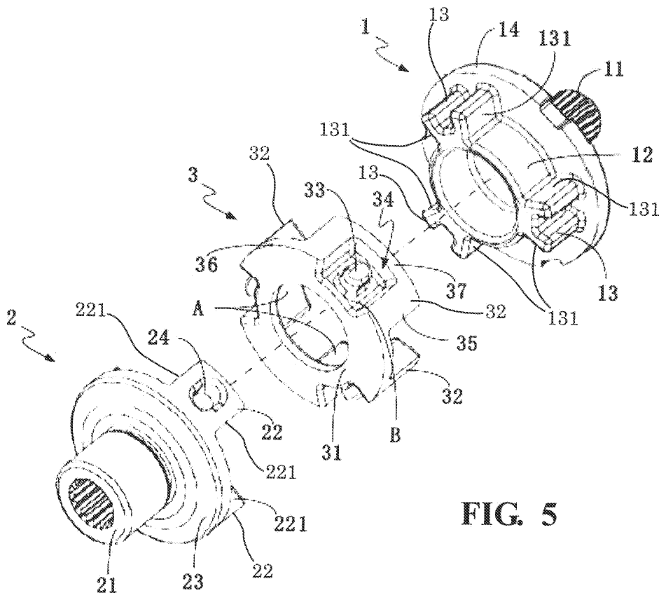

It is to be understood that, to achieve the function of the coupling to transmit torque between two shaft members S1, S2, when one of the first half coupling 1 and the second half coupling 2 rotates as an active member, another of the first half coupling 1 and the second half coupling 2 can be driven by the active member to rotate as a passive member, the first half coupling 1 and the second half coupling 2 should at least partially overlap in the direction of rotating around the flexible coupling. Referring to FIG. 4 and FIG. 5, the first transmission portions 13 extend along the radial direction of the first half coupling 1 so that two sides of the first transmission portions 13 along the rotation direction have first sidewalls 131 extending along the radial direction of the first half coupling 1. Moreover, the second transmission portions 22 extend along the radial direction of the second half coupling 2 so that two sides of the second transmission portions 22 along the rotation direction have second sidewalls 221 extending along the radial direction of the second half coupling 2. When the first half coupling 1, the second half coupling 2 and the flexible member 3 are assembled together, the first sidewalls 131 and the second sidewalls 221 overlap each other in the direction of rotating around the flexible coupling 20. Thus, the first transmission portions 13 and the second transmission portions 22 can transmit torque and rotate synchronously through the flexible member 3 when the active member of the first half coupling 1 and the second half coupling 2 rotates.

In general, the first half coupling 1 and the second half coupling 2 may be slidably disposed on corresponding transmission shafts by splines or may be fixedly disposed on corresponding transmission shafts by flanges, pins, flat keys or the like. The first half coupling 1 and the second half coupling 2 may be made of iron, aluminum metal or alloy. The first half coupling 1 and the second half coupling 2 have a first base 11 extending along the axial direction of the flexible coupling 20 and a second base 21 extending along the axial direction of the flexible coupling 20, respectively. Preferably, the support portion 12 and the first transmission portions 13 are integrally formed with the first base 11, and the second transmission portions 22 are integrally formed with the second base 21. For example, the first half coupling 1 and the second half coupling 2 may be formed by die casting, and this is not limited herein. The flexible member 3 is made of a flexible material such as rubber. Moreover, the flexible member 3 has a third base 31 extending by a certain thickness along the axial direction of the flexible coupling. Preferably, the connection portions 32 are uniformly distributed on the circumference of one end face of the third base 31 in the axial direction.

In the radial direction of the flexible coupling 20, the connection portions 32 of the flexible member 3 are each limited between the support portion 12 of the first half coupling 1 and a second transmission portion 22 of the second half coupling 2. It is to be understood that, when the first half coupling 1 and the second half coupling 2 have angular misalignment and axial misalignment or when the flexible member 3 is aged and shrinks due to long-term use, the angle between two adjacent connection portions 32 should be less than 180 degrees to prevent the flexible member 3 from being disengaged from between the two adjacent connection portions 32. Moreover, it is to be understood that to ensure that the flexible coupling 20 can rotate stably and avoid periodic vibration during rotation due to the asymmetry of the structure of the flexible coupling 20, the first half coupling 1, the second half coupling 2 and the flexible member 3 are each preferably a centrosymmetric shape. That is, the first transmission portions 13, the second connection portions 22 and the connection portions 32 are symmetrically distributed, with respect to the rotational axis of the flexible coupling 20, on the first half coupling 1, the second half coupling 2 and the flexible member 3, respectively.

In the axial direction of the flexible coupling 20, a first flange portion 14 and a second flange portion 23 may be disposed at the end or middle section of the first half coupling 1 and the end or middle section of the second half coupling 2, respectively, so that the flexible member 3 can be clamped by the first flange portion 14 and the second flange portion 23, thereby limiting the disengagement of the flexible member 3 along the axial direction.

Exemplarily, as shown in FIG. 4, in the first half coupling 1, the first flange portion 14 in the shape of a disk is disposed at the middle section of the first base 11 in the axial direction. The first base 11 is provided with a shaft connection structure connected to an external shaft member. The shaft connection structure is disposed on a side of the first flange portion 14 facing away from the second half coupling 2. The support portion 12 is disposed at a side of the first base 11 located at a side of the second flange portion 23 facing the second half coupling 2. The first transmission portions 13 are uniformly distributed on the outer circumference of the support portion 12. Moreover, the first transmission portions 13 extend along the radial direction of the first base 11. In the second half coupling 2, the second flange portion 23 in the shape of a disk is disposed at an axial end of the second base 21. The second base 21 serves as a shaft connection structure connected to another external shaft member. The second transmission portions 22 are disposed on the circumference of the end face of the second flange portion 23 facing away from the second base 21. Moreover, the second transmission portions 22 extend along the axial direction of the second base 21.

Of course, in other embodiments, the first flange portion 14 may be different from the independent member as described in this embodiment, that is, the first flange portion 14 independent of the support portion 12 and the first transmission portions 13. In other embodiments, the first flange portion 14 may be a non-independent member formed by part of the support portion 12 and/or part of the first transmission portions 13 that extends along the radial direction of the flexible coupling 20 and that is capable of stopping the flexible member 3 in the axial direction. Similarly, the second flange portion 23 may be a non-independent member formed by part of the second transmission portions 22 that extends along the radial direction of the flexible coupling 20 and that is capable of stopping the flexible member 3 in the axial direction. This is not limited herein.

With continued reference to FIG. 4 and in conjunction with FIG. 5 and FIG. 6, the flexible coupling 20 may further include a stop portion disposed between the flexible member 3 and the first half coupling 1 or between the flexible member 3 and the second half coupling 2. The stop portion is configured to limit the movement of the flexible member 3 relative to the first half coupling 1 or the second half coupling 2 along the axial direction. Thus, when the axial deviation of the first half coupling 1 and the second half coupling 2 occurs during operation and thereby makes the spacing of the first flange portion 14 between the second flange portion 23 greater than the thickness of the flexible member 3 and weakens the limiting effect on the flexible member 3 in the axial direction, the stop portion can always retain the flexible member 3 on the first half coupling 1 or the second half coupling 2, thereby effectively preventing the disengagement of the flexible member 3 and preventing the flexible member 3 from being sheared and damaged by the first half coupling 1 and the second half coupling 2 when the flexible member 3 moves between the first half coupling 1 and the second half coupling 2. Moreover, in the transportation process, the flexible member 3 can be mounted and retained on the first half coupling 1 or the second half coupling 2 in advance by the preceding stop portion, thereby avoiding the loss of members.

Exemplarily, the stop portion includes a first insertion portion 33 integrally formed in the flexible member 3 and a second insertion portion 24 integrally formed in the second half coupling 2. The first insertion portion 33 is inserted in the second insertion portion 24 along the radial direction when the flexible member 3 is mounted on the second half coupling 2 for providing a retention configuration. Other types of retention configurations may be provided, such as a fastened retention, an overmolded retention, a fused retention, a snap-fitted retention, a press-fitted retention as non-limiting examples. A recess 34 is formed in the radial outer surface of each connection portion 32. A protruding block as the first insertion portion 33 is disposed in the middle of the recess 34. Among the second transmission portions 22, a second transmission portion 22 has a through hole or a blind hole extending from the radial inner side of the second transmission portion 22 to the radial outer side of the second transmission portion 22 to serve as the second insertion portion 24. Thus, the first insertion portion 33 can be inserted into the second insertion portion 24 when the flexible member 3 is mounted onto the second half coupling 2. Moreover, upon the second transmission portion 22 is disposed in the recess 34, the second transmission portion 22 overlaps the connection portion 32 of the flexible member 3 in the rotation direction of the flexible coupling, thereby overlapping the second transmission portion 22 between connection portions 32 in the rotation direction of the flexible coupling 20.

Alternatively, in other embodiments, the preceding protruding block and the preceding hole can be disposed on the second half coupling 2 and the flexible member 3, respectively. In addition, the preceding protruding block and the preceding hole may be other structures which can be inserted/fitted/stopped. In addition, the preceding first insertion portion 33 may be disposed on the first half coupling 1 to position the flexible member 3 on the first half coupling 1. For example, a protruding block, a hole or another structure may be disposed on the first transmission portion 13 or the support portion 12. The preceding structures may be flexibly selected and adjusted and are not limited herein.

To prevent rigid collision and friction between the first half coupling 1 and the second half coupling 2 during the transmission process, in this embodiment, the flexible member 3 further includes first separation portions 35. The first separation portions 35 are configured to separate the first transmission portions 13 from the second transmission portions 22. Further, the flexible member 3 may include second separation portions 36. The second separation portions 36 are configured to separate the first transmission portions 13 from the second flange portion 23. Still further, the flexible member 3 may include third separation portions 37. The third separation portions 37 are configured to separate the second transmission portions 22 from the first flange portion 14. The first separation portions 35, the second separation portions 36, and the third separation portions 37 may be integrally formed with the connection portions 32 on the third base 31.

Apparently, the preceding embodiments of the present invention are only illustrative of the present invention and are not intended to limit the implementations of the present invention. Those of ordinary skill in the art can make various apparent modifications, adaptations, and substitutions without departing from the scope of the present invention. Implementations of the present invention cannot be and do not need to be all exhausted herein. Any modifications, equivalent substitutions, and improvements made within the spirit and principle of the present invention fall within the scope of the claims of the present invention.

What is claimed is:

1. A flexible coupling, comprising:
a first half coupling;
a second half coupling; and
a flexible member connected between the first half coupling and the second half coupling;
wherein a retention configuration is provided between the flexible member and one of the first half coupling and the second half coupling.

2. The flexible coupling according to claim 1, wherein one end face of the flexible member is provided with at least two connection portions extending along an axial direction;
the first half coupling has a support portion configured to support a radially inner side surface of each of the at least two connection portions and first transmission portions configured to fill circumferential gaps between the at least two connection portions; and
the second half coupling has second transmission portions equal in number to the at least two connection portions, and the second transmission portions cover outer side surfaces of the at least two connection portions in a one-to-one manner.

3. The flexible coupling according to claim 1, further comprising a stop portion disposed between the flexible member and the first half coupling or between the flexible member and the second half coupling, wherein the stop portion is configured to limit movement of the flexible member relative to the first half coupling or the second half coupling.

4. The flexible coupling according to claim 3, wherein the stop portion has a first insertion portion disposed on the flexible member and a second insertion portion disposed on the first half coupling or the second half coupling, and the first insertion portion is inserted in the second insertion portion along a radial direction when the flexible member is mounted on the first half coupling or the second half coupling.

5. The flexible coupling according to claim 1, wherein the flexible member has first separation portions, and the first separation portions are configured to separate the first transmission portions from the second transmission portions.

6. The flexible coupling according to claim 1, wherein the first half coupling has a first flange portion and the second half coupling has a second flange portion, and the first flange portion and the second flange portion are configured to clamp the flexible member.

7. The flexible coupling according to claim 6, wherein the flexible member has second separation portions configured to separate the first transmission portions from the second flange portion.

8. The flexible coupling according to claim 6, wherein the flexible member has third separation portions configured to separate the second transmission portions from the first flange portion.

9. The flexible coupling according to claim 1, wherein the at least two connection portions are uniformly distributed along a circumference of an end face of the flexible member.

10. The flexible coupling according to claim 1, wherein the support portion and the first transmission portions are integrally formed in the first half coupling, and the second transmission portions are integrally formed in the second half coupling.

11. The flexible coupling according to claim 1, wherein the first half coupling is configured for attachment to one of a power drive unit and a telescoping unit of an electromechanical actuator, and the second half coupling is configured for attachment to the other of the power drive unit and the telescoping unit of the electromechanical actuator.

12. An actuator, comprising:
a power drive unit;
a telescoping unit; and
a flexible coupling operably connecting the power drive unit to the telescoping unit,
wherein the flexible coupling includes:
a first half coupling;
a second half coupling;
a flexible member connected between the first half coupling and the second half coupling,
wherein a retention configuration is provided between the flexible member and one of the first half coupling and the second half coupling.

13. The actuator of claim 12, wherein
one end face of the flexible member is provided with at least two connection portions extending along an axial direction;
the first half coupling has a support portion configured to support a radially inner side surface of each of the at least two connection portions and first transmission portions configured to fill circumferential gaps between the at least two connection portions; and
the second half coupling has second transmission portions equal in number to the at least two connection portions, and the second transmission portions cover outer side surfaces of the at least two connection portions in a one-to-one manner.

14. The actuator of claim 12, further comprising a stop portion disposed between the flexible member and the first half coupling or between the flexible member and the second half coupling, wherein the stop portion is configured to limit movement of the flexible member relative to the first half coupling or the second half coupling.

15. The actuator of claim 14, wherein the stop portion has a first insertion portion disposed on the flexible member and a second insertion portion disposed on the first half coupling or the second half coupling, and the first insertion portion is inserted in the second insertion portion along a radial direction when the flexible member is mounted on the first half coupling or the second half coupling.

16. The actuator of claim 12, wherein the flexible member has first separation portions, and the first separation portions are configured to separate the first transmission portions from the second transmission portions.

17. The actuator of claim 12, wherein the first half coupling has a first flange portion and the second half coupling has a second flange portion, and the first flange portion and the second flange portion are configured to clamp the flexible member.

18. The actuator of claim 15, wherein the flexible member has second separation portions configured to separate the first transmission portions from the second flange portion.

19. The actuator of claim 15, wherein the flexible member has third separation portions configured to separate the second transmission portions from the first flange portion.

20. The actuator of claim 12, wherein one of:
the at least two connection portions are uniformly distributed along a circumference of an end face of the flexible member;
the support portion and the first transmission portions are integrally formed in the first half coupling, and the second transmission portions are integrally formed in the second half coupling; and
the stop portion retains the flexible member on the first half coupling or the second half coupling to prevent disengagement of the flexible member from the first half coupling or the second half coupling.
